(19) United States
(12) Patent Application Publication
(10) Pub. No.: US 2011/0041075 A1
(43) Pub. Date: Feb. 17, 2011

(54) SEPARATING REPUTATION OF USERS IN DIFFERENT ROLES

(75) Inventors: Michal Cierniak, Palo Alto, CA (US); Na Tang, San Jose, CA (US)

Correspondence Address: HARRITY & HARRITY, LLP, 11350 Random Hills Road, SUITE 600, FAIRFAX, VA, 22030, US

(73) Assignee: GOOGLE INC., Mountain View, CA (US)

(21) Appl. No.: 12/540,045

(22) Filed: Aug. 12, 2009

(51) Int. Cl. G06F 3/00

(52) U.S. Cl. 715/745

(57) ABSTRACT

One or more server devices may determine a first reputation for a user acting in a first role and determine a second reputation for the user acting in a second role. The second role is different than the first role. The one or more server devices may further associate, in a memory associated with the one or more server devices, an identifier of the user with a first value representing the first reputation and a second value representing the second reputation. The one or more server devices may also provide a ranked list of users, the user being placed in the ranked list at a location based on the first reputation or the second reputation.

### BACKGROUND

Some systems rely on users to provide content and rate content provided by other users. For example, Amazon.com allows users to review products offered on that web site and to rate the reviews provided by reviewers. In some situations, a particular user may act as both an author, by submitting a review, and a rater, by rating a review submitted by another user.

### SUMMARY

According to one implementation, a method may be performed by one or more server devices. The method may include receiving, from a user and at a processor of the one or more server devices, a first comment associated with a web page, the user acting in an author capacity with respect to the first comment; receiving, from the user and at a processor of the one or more server devices, a rating of a second comment, the second comment being different from the first comment, the user acting in a rater capacity with respect to the second comment; calculating, using a processor of the one or more server devices, a first ranking score for the user acting in the author capacity based on one or more first signals; calculating, using a processor of the one or more server devices, a second ranking score for the user acting in the rater capacity based on one or more second signals, where the one or more second signals are different from the one or more first signals; and providing one of a first ranked list that includes a plurality of authors, the user being placed in the first list according to the first ranking score, or a second ranked list that includes a plurality of raters, the user being placed in the second list according to the second ranking score.

According to another implementation, one or more server devices may include a processor and a memory. The processor may receive, from a user, a first comment for a web page, the user acting in an author capacity with respect to the first comment; receive, from the user, a rating of a second comment, the second comment being different from the first comment, the user acting in a rater capacity with respect to the second comment; determine a first ranking score for the user acting in the author capacity, the first ranking score being based on one or more first signals; and determine a second ranking score for the user acting in the rater capacity, the second ranking score being based on one or more second signals, the one or more second signals being different from the one or more first signals. The memory may store the first ranking score, and store the second ranking score.

According to yet another implementation, a system may include one or more devices. The one or more devices may include means for determining a first reputation for a user in an author capacity; means for determining a second reputation for the user in a rater capacity, the second reputation being determined differently than the first reputation; means for determining an overall reputation for the user based on the first reputation and the second reputation; and means for providing a ranked list of users, the user being placed in the list at a location based on the overall reputation.

According to a further implementation, a computer-readable medium may contain instructions executable by one or more devices. The computer-readable medium may include one or more instructions to represent a plurality of users, acting in author capacities, as first nodes; one or more instructions to represent the plurality of users, acting in rater capacities, as second nodes; one or more instructions to represent a plurality of comments as third nodes; one or more instructions to form first edges from the first nodes to the third nodes based on relationships between the first nodes and the third nodes; one or more instructions to form second edges from the third nodes to the first nodes based on the relationships between the first nodes and the third nodes; one or more instructions to form third edges from the second nodes to the third nodes based on relationships between the second nodes and the third nodes; one or more instructions to form fourth edges from the first nodes to the second nodes based on relationships between the first nodes and the second nodes; and one or more instructions to form fifth edges from the second nodes to the first nodes based on the relationships between the first nodes and the second nodes. The computer-readable medium may further include one or more instructions to assign initial values to the first nodes, the second nodes, and the third nodes; one or more instructions to run iterations of a graph algorithm to obtain ranking values, the iterations being run until values of the first nodes, second nodes, and third nodes converge or a number of iterations has been reached, where the ranking value of each first node reflects a reputation of the corresponding user acting in the author capacity, where the ranking value of each second node reflects a reputation of the corresponding user acting in the rater capacity, and where the ranking value of each third node reflects an indication of quality of the corresponding comment; and one or more instructions to provide at least one of a list of authors that is ordered based on the ranking values of the first nodes, a list of raters that is ordered based on the ranking values of the second nodes, or a ranked list of comments, the comments in the ranked list being selected based using the ranking values of the comments in the ranked list.

In another implementation, a method may include maintaining, in a memory associated with one or more server devices, a database that associates, for each user of a plurality of users, an identifier for the user with information identifying a first ranking score of the user acting in an author capacity with respect to one or more first comments and a second ranking score of the user acting in a rater capacity with respect to one or more second comments; receiving, at a processor associated with the one or more server devices, a request for a ranking of raters; retrieving, in response to receiving the request and using a processor associated with the one or more server devices, the user identifiers and the second ranking scores, associated with the users, from the database; and providing, using a processor associated with one or more server devices, a list of the user identifiers, where the user identifiers in the list are ranked according to the second ranking scores associated with the users.

In still yet another implementation, a method may be performed by one or more server devices. The method may include determining, using a processor of the one or more server devices, a first reputation for a user acting in a first role; determining, using a processor of the one or more server devices, a second reputation for the user acting in a second role, the second role being different than the first role; associating, in a memory associated with the one or more server devices, an identifier of the user with a first value representing the first reputation and a second value representing the second reputation; and providing, using a processor of the one or more server devices, a ranked list of users, the user being placed in the ranked list at a location based on the first reputation or the second reputation.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram illustrating an overview of an exemplary implementation described herein;

FIG. 2 is a diagram of an exemplary environment in which systems and methods described herein may be implemented;

FIG. 3 is a diagram of exemplary components of a client or a server of FIG. 2;

FIG. 4 is a diagram of functional components of a server of FIG. 2;

FIG. 5 is a diagram of functional components of the comments component of FIG. 4;

FIGS. 6 and 7 are diagrams of exemplary databases that may be associated with the comments component of FIG. 4;

FIG. 8 is a flowchart of an exemplary process for determining initial author scores;

FIG. 9 is a flowchart of an exemplary process for determining initial rater scores;

FIG. 10 is a flowchart of an exemplary process for determining initial comment scores;

FIG. 11 is a flowchart of an exemplary process for determining ranking scores for authors, raters, and comments;

FIG. 12 is a flowchart of an exemplary process for providing user information;

FIG. 13 is a diagram of an exemplary graphical user interface that may provide user information;

FIG. 14 is a flowchart of an exemplary process for providing rater rankings;

FIGS. 15-17 are diagrams of exemplary graphical user interfaces that may provide rater ranking information; and

FIG. 18 is a diagram of an exemplary graphical user interface that may provide user ranking information.

### DETAILED DESCRIPTION

The following detailed description refers to the accompanying drawings. The same reference numbers in different drawings may identify the same or similar elements.

### Overview

For some documents, users might like to see comments regarding these documents. A “comment,” as used herein, may include text, audio data, video data, and/or image data that provides an opinion of, or otherwise remarks upon, the contents of a document or a portion of a document. One example of a comment may include a document whose sole purpose is to contain the opinion/remark. Another example of a comment may include a blog post. Yet another example of a comment may include a web page or a news article that remarks upon an item (e.g., a product, a service, a company, a web site, a person, a geographic location, or something else that can be remarked upon).

A “document,” as the term is used herein, is to be broadly interpreted to include any machine-readable and machine-storable work product. A document may include, for example, an e-mail, a web site, a file, a combination of files, one or more files with embedded links to other files, a news group posting, a news article, a blog, a business listing, an electronic version of printed text, a web advertisement, etc. In the context of the Internet, a common document is a web page. Documents often include textual information and may include embedded information (such as meta information, images, hyperlinks, etc.) and/or embedded instructions (such as Javascript, etc.).

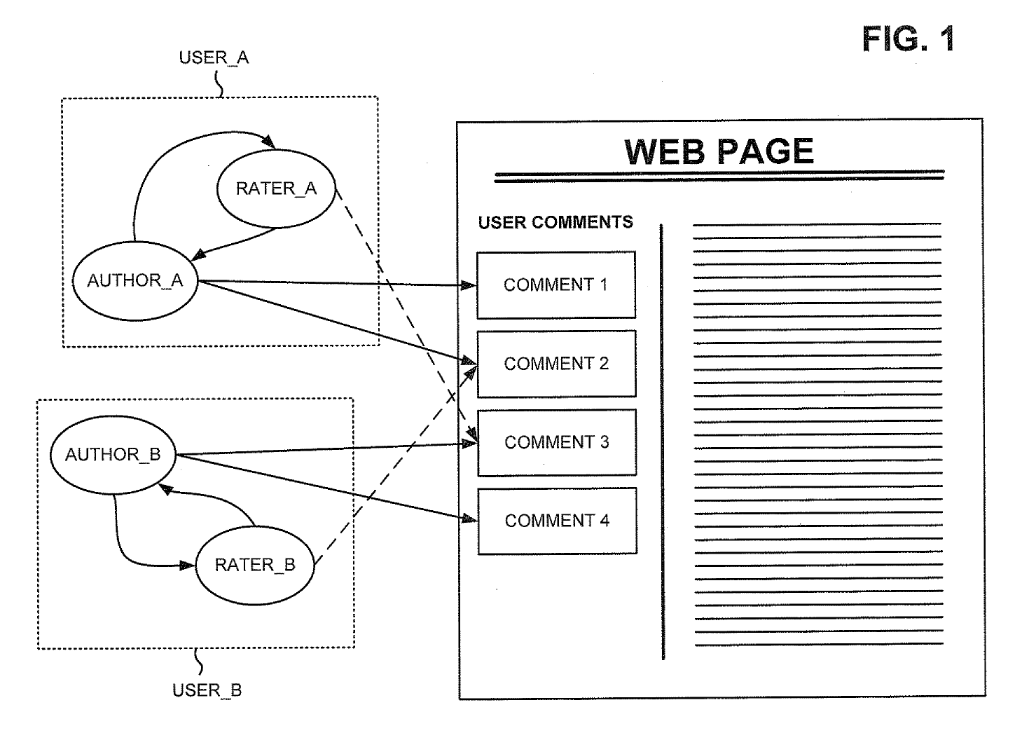

FIG. 1 is a diagram illustrating an overview of an exemplary implementation described herein. As shown in FIG. 1, assume that a web page provides information about a particular topic (shown simply as “web page” in FIG. 1). A user (shown as “user_A” in FIG. 1) may decide to provide a comment regarding a web page. In this case, the user might activate a commenting feature to provide the comment. The user may then provide an opinion or remark as the content of the comment. In the example shown in FIG. 1, user_A has provided two comments regarding the web page (shown as “comment 1” and “comment 2” in FIG. 1). In addition, another user (shown as “user_B” in FIG. 1) has also provided two comments (shown as “comment 3” and “comment 4” in FIG. 1) regarding the web page. The comments may be stored in a database in association with the web page.

In addition to providing comments, users may rate comments authored by other users. For example, as shown by the dotted line in FIG. 1, user_A has rated comment 3, authored by user_B. The rating may include a positive indication (e.g., that user_A found the comment helpful, agreed with the comment, liked the comment, etc.) or a negative indication (e.g., that user_A found the comment unhelpful, disagreed with the comment, disliked the comment, etc.). As further shown in FIG. 1, user_B has rated comment 2, authored by user_A. In this way, user_A and user_B may act as authors for comments provided for the portion of the web page and raters for ratings given to comments provided by others.

In one implementation, a user's reputation may be separated into different roles (e.g., an author role and a rater role) and the user's reputation with respect to these different roles may individually contribute to the ranking of comments with which the user is associated in an author capacity or a rater capacity. In addition, the different roles may affect the ranking of each other. That is, a user's author rank may affect the user's rater rank, and the user's rater rank may affect the user's author rank.

The number of users, comments, and web pages, illustrated in FIG. 1, is provided for explanatory purposes only. It will be appreciated that, in practice, there may be more users and/or web pages and more or fewer comments.

### Exemplary Environment

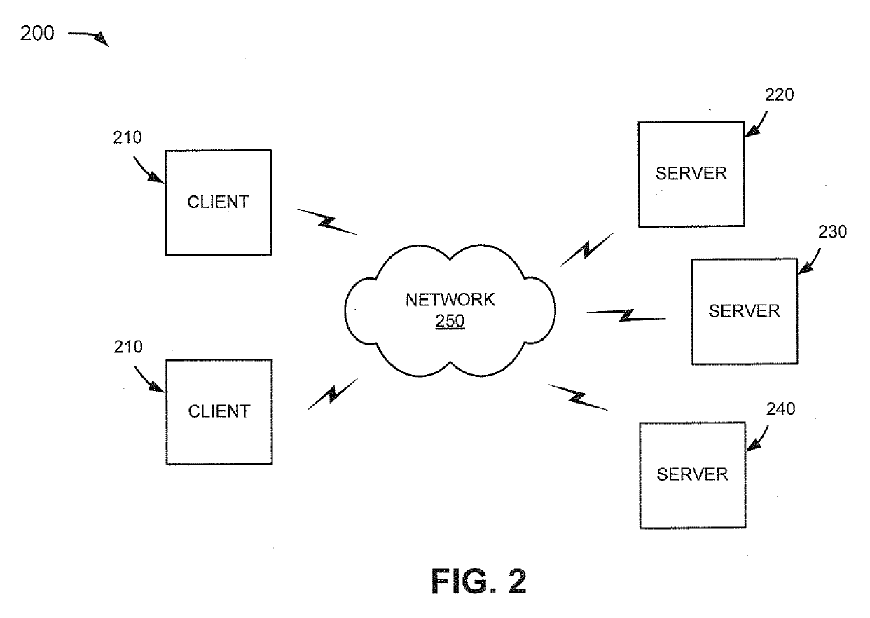

FIG. 2 is a diagram of an exemplary environment 200 in which systems and methods described herein may be implemented. Environment 200 may include multiple clients 210 connected to multiple servers 220-240 via a network 250. Two clients 210 and three servers 220-240 have been illustrated as connected to network 250 for simplicity. In practice, there may be more or fewer clients and servers. Also, in some instances, a client may perform a function of a server and a server may perform a function of a client.

Clients 210 may include client entities. An entity may be defined as a device, such as a personal computer, a wireless telephone, a personal digital assistant (PDA), a lap top, or another type of computation or communication device, a thread or process running on one of these devices, and/or an object executed by one of these devices. In one implementation, a client 210 may include a browser application that permits documents to be searched and/or accessed. Client 210 may also include software, such as a plug-in, an applet, a dynamic link library (DLL), or another executable object or process, that may operate in conjunction with (or be integrated into) the browser to obtain and display comments. Client 210 may obtain the software from server 220 or from a third party, such as a third party server, disk, tape, network, CD-ROM, etc. Alternatively, the software may be pre-installed on client 210. For the description to follow, the software will be described as integrated into the browser.

In one implementation, as described herein, the browser may provide a commenting function. The commenting function may permit a user to generate a comment regarding a document, permit the user to view a comment that was previously generated by the user or by other users, and/or permit the user to rate a previously-generated comment.

Servers 220-240 may include server entities that gather, process, search, and/or maintain documents in a manner described herein. In one implementation, server 220 may gather, process, and/or maintain comments that are associated with particular documents. Servers 230 and 240 may store or maintain comments and/or documents.

While servers 220-240 are shown as separate entities, it may be possible for one or more of servers 220-240 to perform one or more of the functions of another one or more of servers 220-240. For example, it may be possible that two or more of servers 220-240 are implemented as a single server. It may also be possible for a single one of servers 220-240 to be implemented as two or more separate (and possibly distributed) devices.

Network 250 may include any type of network, such as a local area network (LAN), a wide area network (WAN), a telephone network (e.g., the Public Switched Telephone Network (PSTN) or a cellular network), an intranet, the Internet, or a combination of networks. Clients 210 and servers 220-240 may connect to network 250 via wired and/or wireless connections.

### Exemplary Client/Server Architecture

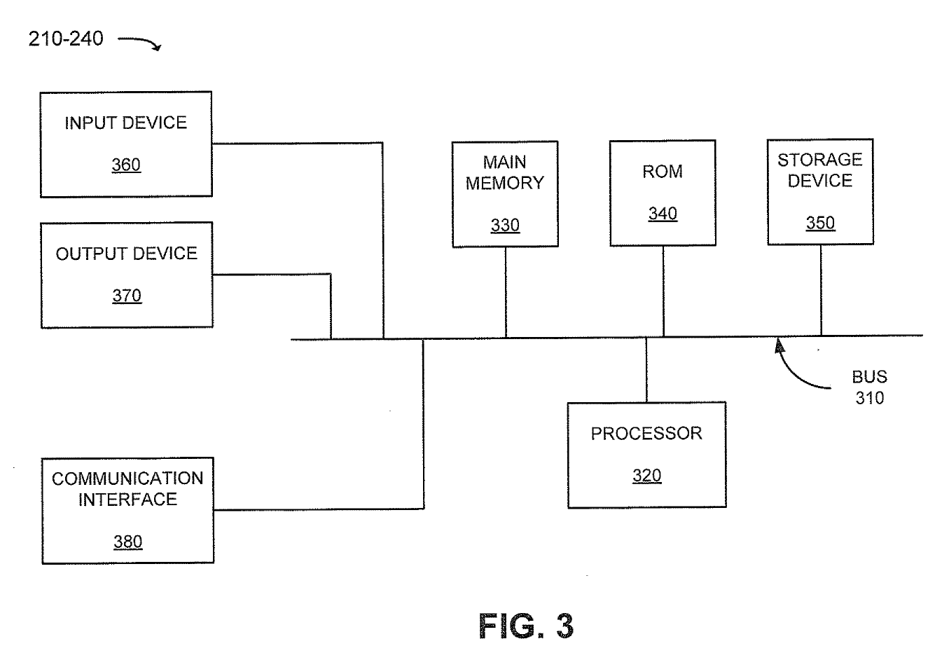

FIG. 3 is a diagram of exemplary components of a client or server entity (hereinafter called “client/server entity”), which may correspond to one or more of clients 210 and/or servers 220-240. As shown in FIG. 3, the client/server entity may include a bus 310, a processor 320, a main memory 330, a read only memory (ROM) 340, a storage device 350, an input device 360, an output device 370, and a communication interface 380. In another implementation, client/server entity may include additional, fewer, different, or differently arranged components than are illustrated in FIG. 3.

Bus 310 may include a path that permits communication among the components of the client/server entity. Processor 320 may include a processor, a microprocessor, or processing logic (e.g., an application specific integrated circuit (ASIC) or a field programmable gate array (FPGA)) that may interpret and execute instructions. Main memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive, or a removable form of memory, such as a flash memory.

Input device 360 may include a mechanism that permits an operator to input information to the client/server entity, such as a keyboard, a mouse, a button, a pen, a touch screen, voice recognition and/or biometric mechanisms, etc. Output device 370 may include a mechanism that outputs information to the operator, including a display, a light emitting diode (LED), a speaker, etc. Communication interface 380 may include any transceiver-like mechanism that enables the client/server entity to communicate with other devices and/or systems. For example, communication interface 380 may include mechanisms for communicating with another device or system via a network, such as network 250.

As will be described in detail below, the client/server entity may perform certain operations relating to determining the reputations of users with respect to their roles as authors and raters. The client/server entity may perform these operations in response to processor 320 executing software instructions contained in a computer-readable medium, such as memory 330. A computer-readable medium may be defined as a logical or physical memory device. A logical memory device may include a space within a single physical memory device or spread across multiple physical memory devices.

The software instructions may be read into memory 330 from another computer-readable medium, such as storage device 350, or from another device via communication interface 380. The software instructions contained in memory 330 may cause processor 320 to perform processes that will be described later. Alternatively, hardwired circuitry may be used in place of or in combination with software instructions to implement processes described herein. Thus, implementations described herein are not limited to any specific combination of hardware circuitry and software.

### Exemplary Functional Components of Server

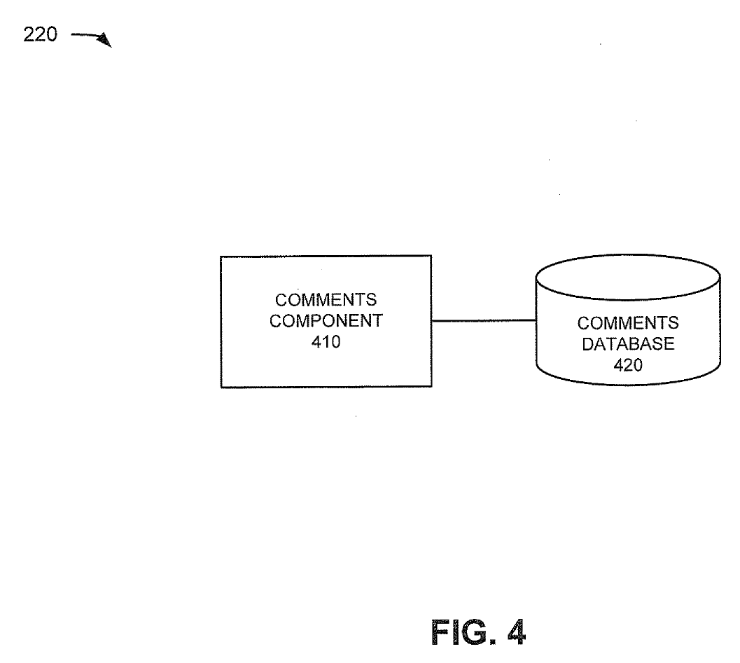

FIG. 4 is a diagram of exemplary functional components of server 220. As shown in FIG. 4, server 220 may include a comments component 410 and a comments database 420. In another implementation, server 220 may include more or fewer functional components. For example, one or more of the functional components shown in FIG. 4 may be located in a device separate from server 220.

Comments component 410 may interact with clients 210 to obtain and/or serve comments. For example, a user of a client 210 may access a particular document and generate a comment regarding the document. The document may include some amount of text (e.g., some number of words), an image, a video, or some other form of media. Client 210 may send the comment and information regarding the document to comments component 410.

Comments component 410 may receive the comment provided by a client 210 in connection with the particular document. Comments component 410 may gather certain information regarding the comment, such as information regarding the author of the comment, a timestamp that indicates a date and/or time at which comment was created, the content of the comment, and/or an address (e.g., a URL) associated with the document. Comments component 410 may receive at least some of this information from client 210. Comments component 410 may store the information regarding the comment in comments database 420.

Comments component 410 may also serve a comment in connection with a document accessed by a client 210. In one implementation, comments component 410 may obtain a comment from comments database 420 and provide that comment to client 210 when client 210 accesses a document with which that comment is associated in comments database 420.

Comments component 410 may also receive ratings for comments served by comments component 410. When a comment is presented to a user in connection with presentation of a particular document, the user may be given the opportunity to provide explicit feedback on that comment. For example, the user may indicate whether the comment is meaningful (e.g., a positive vote) or not meaningful (e.g., a negative vote) to the user (with respect to the particular document) by selecting an appropriate voting button. This user feedback (positive or negative) may be considered a rating for the comment by the user. The rating may be a simple positive or negative indication, as described above, or may represent a degree of like/dislike for a comment (e.g., the rating may be represented as a scale from, for example, 1 to 5). Client 210 may send the rating and other information, such as information identifying the particular comment on which the rating is provided, information identifying the user, etc. to comments component 410. Comments component 410 may store the ratings in comments database 420 in association with information identifying the users that submitted the ratings and the comments for which the ratings were submitted.

Comments database 420 may store information regarding comments. In one implementation, comments database 420 may include various fields that are separately searchable. Comments component 410 may search comments database 420 to identify comments associated with a particular author, a particular rater, or a particular document.

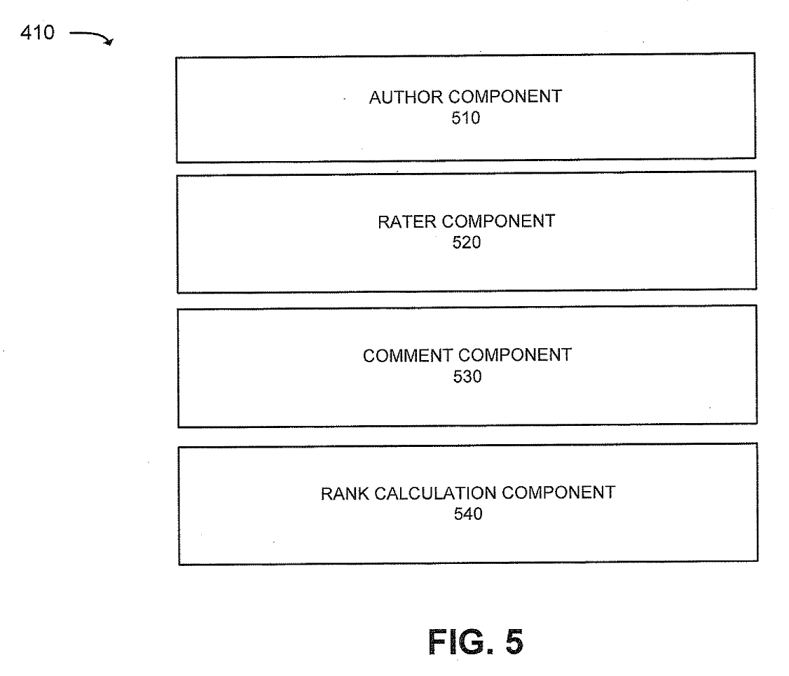

FIG. 5 is a diagram of functional components of comments component 410 of FIG. 4. As shown in FIG. 5, comments component 410 may include an author component 510, a rater component 520, a comment component 530, and a rank calculation component 540. In another implementation, comments component 410 may include more or fewer functional components. For example, one or more of the functional components shown in FIG. 5 may be located in a device separate from server 220 or may be associated with a different functional component of server 220.

Author component 510 may receive signals associated with an author of a comment and calculate an initial author score for the author based on the signals. In one implementation, author component 510 may calculate an initial author score for a user based on, for example, the length of time that the user has been a user of the system (e.g., the commenting system) or registered with the system (e.g., with the assumption that the longer that a user has been a user of the system (or registered with the system), the more trustworthy the user is). Author component 510 may further calculate the initial author score based on additional or other signals relating to the author. For example, the age of the author, if known, may be used in the initial author score calculation (e.g., with the assumption, for example, that the users between a certain age range may provide better comments). In addition, the education background of the author, if known, may be used in the initial author score calculation (e.g., with the assumption, for example, that the users with higher degrees may provide better comments). When multiple signals are used in calculating the initial author score, author component 510 may weigh some of the signals more heavily than other signals.

Rater component 520 may receive signals associated with a rater of a comment and calculate an initial score for the rater based on the signals. In one implementation, rater component 520 may calculate an initial rater score for a user based on the ratings provided by the user on a group of comments and the ratings provided by other users for the same group of comments. For example, rater component 520 may identify the comment ratings submitted by the user and compare how the user rated the different comments to how the majority of users rated the different comments. If rater component 520 determines that the user has agreed with the consensus on a majority of the user's ratings, rater component 520 may calculate a higher (i.e., better) initial rater score for that user. Similarly, when rater component 520 determines that the user has disagreed with the consensus on a majority of the user's ratings, rater component 520 may calculate a lower (i.e., worse) initial rater score for that user. Rater component 520 may consider other signals in calculating the initial rater score. When multiple signals are used in calculating the initial rater score, rater component 520 may weigh some of the signals more heavily than other signals.

Comment component 530 may receive signals associated with a comment and calculate an initial score for the comment based on the signals. In one implementation, comment component 530 may calculate an initial comment score for a comment based on the length of the comment. In this situation, longer comments (e.g., comments containing more than a threshold number of words) may be considered to be better comments than comments containing a fewer number of words. Comment component 530 may alternatively or additionally consider a language model of the comment. For example, the closer the language of a comment is to Standard English (or some other language), the better the comment may be considered to be. Other signals may alternatively or additionally be used. When multiple signals are used in calculating the initial comment score, comment component 530 may weigh some of the signals more heavily than other signals.

Rank calculation component 540 may combine the initial author scores, initial rater scores, and initial comment scores to calculate author ranking scores, rater ranking scores, and comment ranking scores. The author ranking scores may reflect reputations of the corresponding users as authors. For example, a higher ranking score may reflect that a user has a better reputation as an author over another user with a lower ranking score. The rater ranking scores may reflect reputations of the corresponding users as raters. The comment ranking scores may represent the quality of the corresponding comments.

In one implementation, rank calculation component 540 may calculate the author ranking scores, rater ranking scores, and comment ranking scores based on a graph. For example, rank calculation component 540 may represent every author, every rater, and every comment as nodes. Rank calculation component 540 may further represent relationships between these nodes as edges (or links). For example, an edge may be present between a first node that represents an author and a second node that represents the comment that the author submitted. Thus, author nodes may be linked to the comment nodes that the authors submitted and the comment nodes may be linked to the author nodes, allowing reputations of author nodes to be passed to comment nodes and qualities of comment nodes to be passed to author nodes. Additionally, an edge may be present between a first node that represents a rater and a second node that represents the comment for which the rater has submitted a rating. Thus, rater nodes may be linked to comment nodes and comment nodes may be linked to rater nodes, allowing reputations of rater nodes to be passed to comment nodes and qualities of comment nodes to be passed to rater nodes. Additionally, an edge may be present between a first node that represents a user in his/her author capacity and a second node that represents the user in his/her rater capacity. Thus, for example, referring back to FIG. 1, the node representing author_A may be linked to the node representing rater_A and the node representing rater_A may be linked to the node representing author_A.

In one implementation, some of the edges may be weighed more heavily than other edges. For example, an edge from an author node to a rater node may be assigned a higher weight than the weight assigned to an edge from the rater node to the author node. The different weights may, for example, be based on the observation that an author with a good reputation may likely also be a good rater, but a good rater may not necessarily be a good author.

Once the nodes and edges have been represented in the graph, ranking calculation component 540 may calculate ranking scores for the nodes. In one implementation, rank calculation component 540 may use an algorithm similar to the PageRank™ algorithm to calculate the ranking scores for the nodes. Thus, for example, rank calculation component 540 may assign the initial scores calculated by author component 510, rater component 520, and comment component 530 to the nodes. Rank calculation component 540 may run iterations of the graph algorithm (where all or a portion of the initial scores of the nodes are conveyed to nodes to which the node links) until the ranking scores converge. In another implementation, rank calculation component 540 may terminate running iterations of the graph algorithm after a fixed number of iterations (without checking for convergence). In still another implementation, rank calculation component 540 may terminate running iterations of the graph algorithm when either the values converge or a predefined maximum number of iterations have been reached. In some implementations, rank calculation component 540 may use one or more other algorithms to calculate author ranking scores, rater ranking scores, and comment ranking scores or simply take the initial scores calculated by author component 510, rater component 520, and comment component 530 as the ranking scores. Once calculated, rank calculation component 540 may store the ranking scores in a database, such as databases 600 and 700.

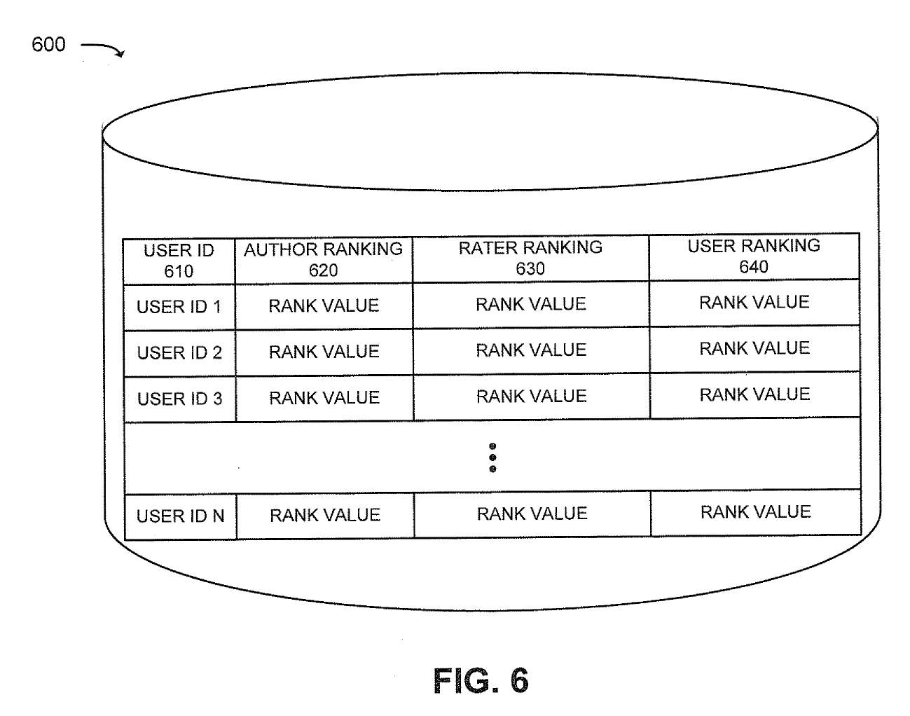

FIG. 6 is a diagram of a first exemplary database 600 that may be associated with comments component 410 of FIG. 4. While one database is described below, it will be appreciated that database 600 may include multiple databases stored locally at server 220 (e.g., in comments database 420), or stored at one or more different and/or possibly remote locations.

As illustrated, database 600 may include a group of entries with the following exemplary fields: a user identifier (ID) field 610, an author ranking field 620, a rater ranking field 630, and a user ranking field 640. Database 600 may contain additional fields (not shown) that aid comment component 410 in providing information relating to users.

User identifier field 610 may store information that identifies a user. For example, user identifier field 610 may store a sequence of characters that uniquely identifies a user. In one implementation, the sequence of characters may correspond to a user name, an e-mail address, or some other type of identification information. Author ranking field 620 may store a value representing the author ranking score (e.g., as calculated by rank calculation component 540) for the particular user, identified in user identifier field 610, when acting in an author capacity. Rater ranking field 630 may store a value representing the rater ranking score (e.g., as calculated by rank calculation component 540) for the particular user, identified in user identifier field 610, when acting in a rater capacity. User ranking field 640 may store a value representing an overall user ranking score for the particular user identified in user identifier field 610. The user ranking score may be calculated by combining the author ranking score with the rater ranking score. In one implementation, rank calculation component 540 may weigh the author ranking score for a particular user more heavily than the rater ranking score for the user, or vice versa. Rank calculation component 540 may then add the weighted scores to produce the user ranking score. Other ways of combining the author ranking score with the rater ranking score may alternatively be used. The user ranking scores may represent overall reputations for the users.

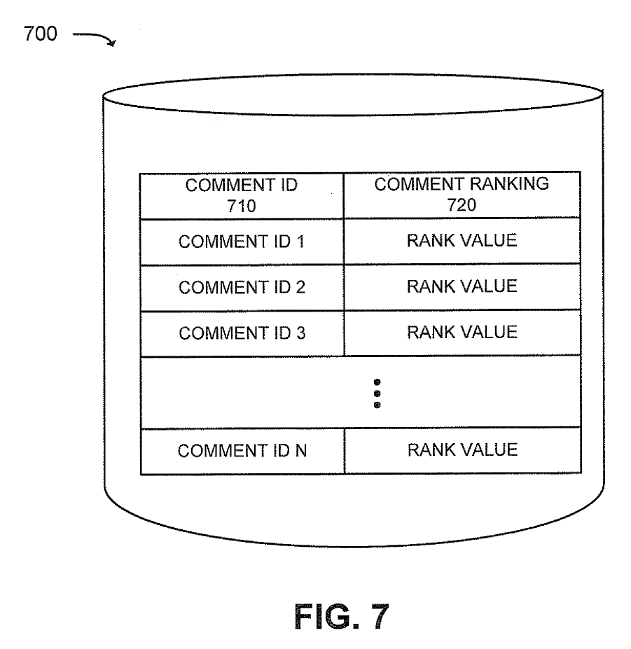

FIG. 7 is a diagram of a second exemplary database 700 that may be associated with comments component 410 of FIG. 4. While one database is described below, it will be appreciated that database 700 may include multiple databases stored locally at server 220 (e.g., in comments database 420), or stored at one or more different and/or possibly remote locations.

As illustrated, database 700 may include a group of entries with the following exemplary fields: a comment identifier field 710 and a comment ranking field 720. Database 700 may contain additional fields (not shown) that aid comment component 410 in providing information relating to comments.

Comment identifier field 710 may store information that identifies a comment. For example, comment identifier field 710 may store a sequence of characters that uniquely identifies a comment. Comment ranking field 720 may store a value representing the comment ranking score (e.g., as calculated by rank calculation component 540) for the particular comment identified in comment identifier field 710.

### Calculating Initial Author Scores

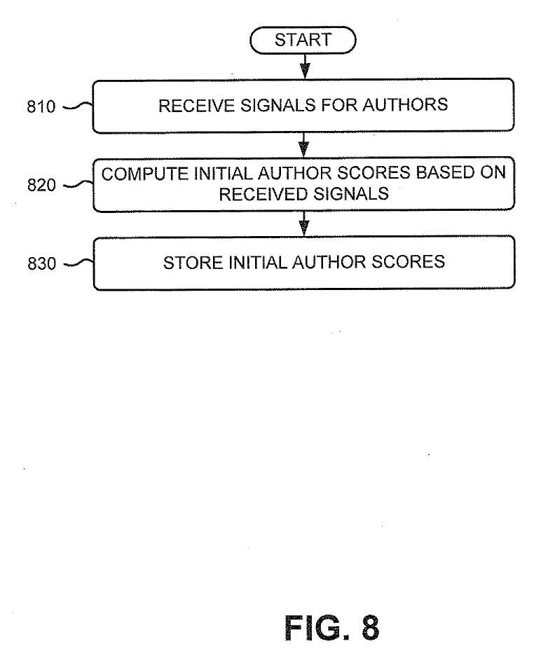

FIG. 8 is a flowchart of an exemplary process for determining initial author scores. In one implementation, the process of FIG. 8 may be performed by one or more components within server 220, client 210, or a combination of client 210 and server 220. In another implementation, the process may be performed by one or more components within another device or a group of devices separate from or including client 210 and/or server 220. Also, while FIG. 8 shows blocks in a particular order, the actual order may differ. For example, some blocks may be performed in parallel or in a different order than shown in FIG. 8.

The process of FIG. 8 may include receiving signals for authors (block 810). The signals may include any information that may be used to determine initial scores for the authors that reflect an initial level of reputation of the authors. For example, the signals for a particular author may include the length of time that the author has been a user of the system (e.g., the commenting system) or registered with the system. With respect to these signals, when an author has been a user of the system for more than some period of time (or has been registered with the system for more than some period of time), the author may be given a higher (i.e., better) score than another author who has been a user of the system for less than the period of time. In addition or alternatively, the signals may include an age of the author. With respect to these signals, an author whose age is between a certain range (e.g., between the ages of 30 years old to 65 years old) may be given a higher (i.e., better) score than another author whose age is outside the range. In addition or alternatively, the signals may include an educational background of the author. With respect to these signals, an author with a higher educational background may be given a higher (i.e., better) score than another author having a lower educational background. Other types of signals may additionally or alternatively be used. For example, the signals may further indicate the quantity of comments submitted by the author. With respect to these signals, an author who submits a quantity of comments that is above a threshold may be given a higher score than another author who submits a quantity of comments that is below the threshold.

The process may further include computing initial author scores based on the received signals (block 820). For example, author component 510 may calculate scores for each of the different author signals received and may combine the scores to obtain the initial author scores. As a very simple example, assume that author component 510 assigns a score to an author based the length of time that the author is a user of the system. For example, if the author has been a user of the system for a very short amount of time (below a first threshold), the author may be assigned a lowest (or worst) score. If the author has been a user of the system for more than the very short amount of time (above the first threshold), but less than a second, longer amount to time (below a second threshold), the author may be assigned a medium score. In addition, if the author has been a user of the system for more than the second, longer amount of time (above the second threshold), the author may be assigned a highest (or best) score.

Once scores for the different signals are calculated, author component 510 may combine the scores to obtain the initial scores for the authors. In one implementation, author component 510 may, for each individual author, add the individual scores for the individual author to obtain an initial author score for the author. Author component 510 may, in some implementations, weigh the score associated with one of the signals more heavily than the score associated with another one of the signals. Other manners of combining the scores to obtain the initial author scores may alternatively be used.

The process may further include storing the initial author scores (block 830). For example, author component 510 may store the initial author scores in a database, such as database 600. In one implementation, author component 510 may store the initial author scores in field 620 in the appropriate rows of database 600.

### Calculating Initial Rater Scores

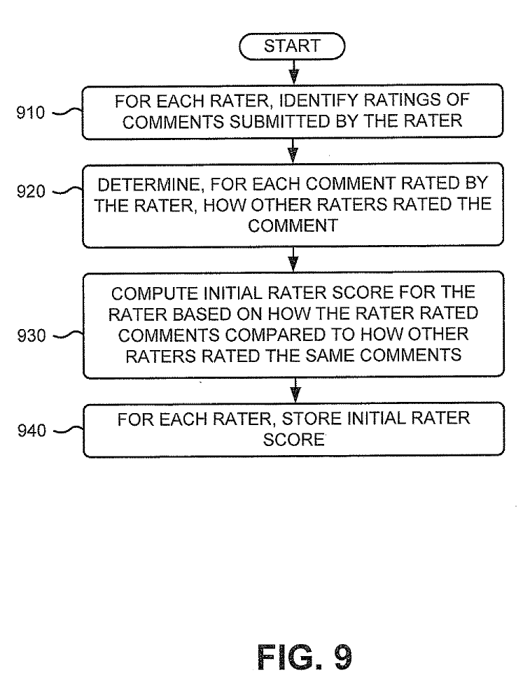

FIG. 9 is a flowchart of an exemplary process for determining initial rater scores. In one implementation, the process of FIG. 9 may be performed by one or more components within server 220, client 210, or a combination of client 210 and server 220. In another implementation, the process may be performed by one or more components within another device or a group of devices separate from or including client 210 and/or server 220. Also, while FIG. 9 shows blocks in a particular order, the actual order may differ. For example, some blocks may be performed in parallel or in a different order than shown in FIG. 9.

The process of FIG. 9 may include identifying, for a rater, ratings of comments submitted by the rater (block 910). As indicated above, comments component 410 may receive ratings for comments served by comments component 410. When a comment is presented to a user in connection with presentation of a particular document, the user may be given the opportunity to provide explicit feedback on that comment. For example, the user may indicate whether the comment is meaningful (e.g., a positive vote) or not meaningful (e.g., a negative vote) to the user (with respect to the particular document) by selecting an appropriate voting button. This user feedback (positive or negative) may be considered a rating for the comment by the user. Client 210 may send the rating and other information, such as information identifying the particular comment on which the rating is provided, information identifying the user, etc. to comments component 410. Comments component 410 may store the ratings in comments database 420 in association with information identifying the users that submitted the ratings and the comments for which the ratings were submitted. Thus, rater component 520 may identify, in comments database 420 and for a particular rater, the ratings submitted by the rater and the comments for which the ratings were submitted.

The process may further include determining, for each comment rated by the rater, how other raters rated the comment (block 920). For example, rater component 520 may access, using information identifying a comment, all the ratings submitted for the comment from comments database 420 and may identify, for each comment, how the other raters rated the comment.

The process may further include computing an initial score for the rater based on how the rater rated the comments and how other raters rated the same comments (block 930). For example, rater component 420 may compare, for each comment that the rater rated, the rater's rating to the ratings submitted by all other raters of the comment. Rater component 420 may calculate a score for each comment based on whether the rater agreed with the majority of raters of the comment. For example, if the rater's rating agreed with the ratings of the majority of raters of the comment, the rater may be assigned a first (or better) score for that particular comment. On the other hand, if the rater's rating disagreed with the ratings of the majority of raters of the comment, the rater may be assigned a second, different (or worse) score for that particular comment. Rater component 420 may add the scores for the comments for which the rater submitted ratings to obtain the initial rater score for the rater. In one implementation, rater component 420 may weigh scores for some of the rater's ratings more heavily than others of the rater's ratings. Other manners of combining the scores to obtain the initial rater score may alternatively be used. In addition, other manners of determining the initial rater score may alternatively be used.

The process may further include storing the initial rater score (block 940). For example, rater component 520 may store the initial rater score in a database, such as database 600. In one implementation, rater component 520 may store the initial rater score in field 630 in the appropriate row of database 600 for the user identifier with which the rater is associated.

### Calculating Initial Comment Scores

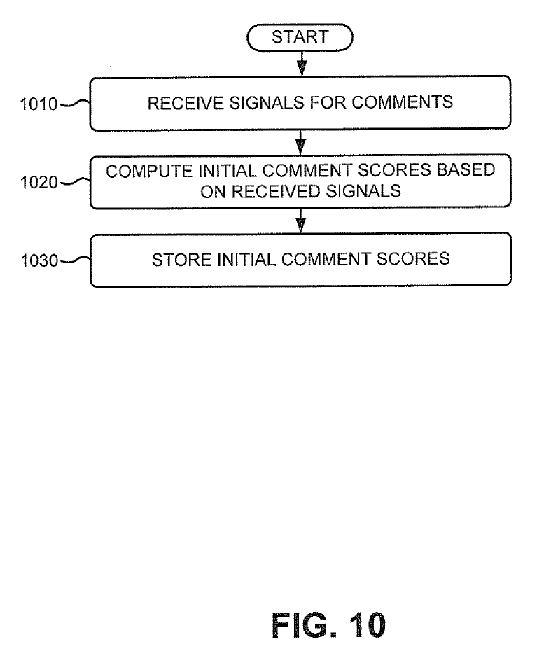

FIG. 10 is a flowchart of an exemplary process for determining initial comment scores. In one implementation, the process of FIG. 10 may be performed by one or more components within server 220, client 210, or a combination of client 210 and server 220. In another implementation, the process may be performed by one or more components within another device or a group of devices separate from or including client 210 and/or server 220. Also, while FIG. 10 shows blocks in a particular order, the actual order may differ. For example, some blocks may be performed in parallel or in a different order than shown in FIG. 10.

The process of FIG. 10 may include receiving signals for comments (block 1010). The signals may include any information that may be used to determine initial scores for the comments that reflect a level of quality of the comments. For example, the signals for a particular comment may include the length of the comment. In this situation, a first comment that contains more than a threshold number of terms may be assigned a higher (or better) score than another comment containing less than the threshold number of terms. In addition or alternatively, the signals may include information identifying how closely the language used in a particular comment matches a particular language model. With respect to these signals, a comment whose language more closely matches Standard English, for example, may be assigned a higher (or better) score than another comment whose language does not closely match Standard English (e.g., comments using slang or abbreviations). Other types of signals may alternatively be used.

The process may further include computing initial comment scores based on the received signals (block 1020). For example, comment component 530 may calculate scores for each of the different signals received and may combine the scores to obtain the initial comment scores. Once scores for the different signals are calculated, comment component 530 may combine the scores to obtain the initial scores for the comments. In one implementation, comment component 530 may add the individual scores for the individual comments to obtain an initial comment score for each individual comment. Comment component 530 may, in some implementations, weigh the score from one of the signals more heavily than the score from another one of the signals. Other manners of combining the scores to obtain the initial comment scores may alternatively be used.

The process may further include storing the initial comment scores (block 1030). For example, comment component 530 may store the initial comment scores in a database, such as database 700. In one implementation, comment component 530 may store the initial comment scores in field 720 in the appropriate rows of database 700.

### Calculating Author, Rater, and Comment Ranking Scores

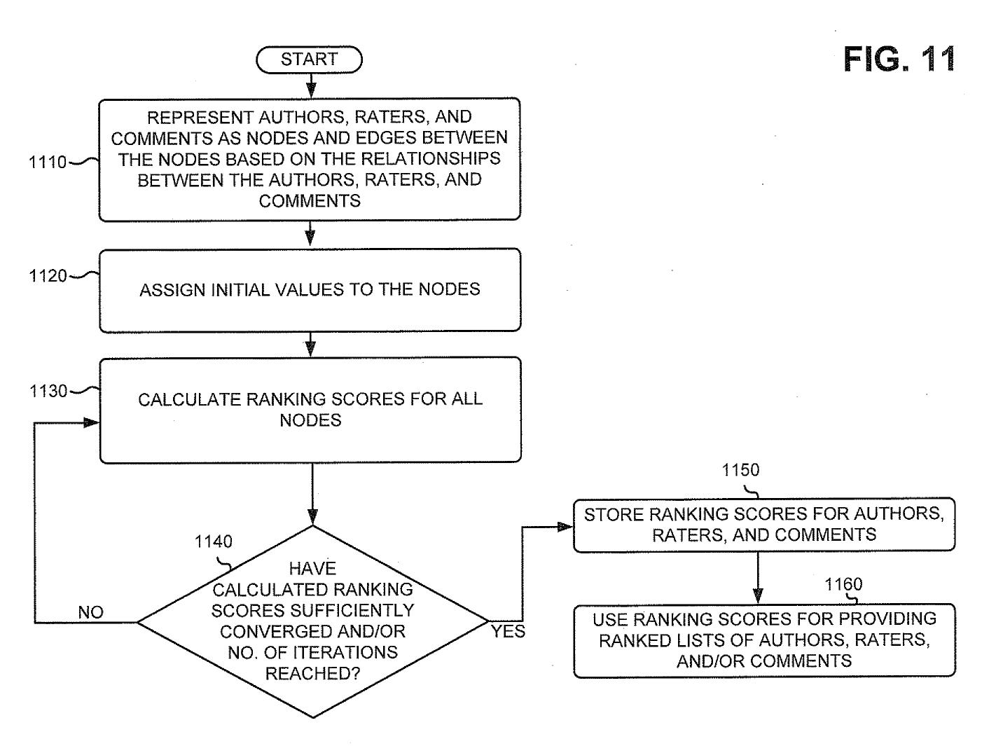

FIG. 11 is a flowchart of an exemplary process for determining ranking scores for authors, raters, and comments. In one implementation, the process of FIG. 11 may be performed by one or more components within server 220, client 210, or a combination of client 210 and server 220. In another implementation, the process may be performed by one or more components within another device or a group of devices separate from or including client 210 and/or server 220. Also, while FIG. 11 shows blocks in a particular order, the actual order may differ. For example, some blocks may be performed in parallel or in a different order than shown in FIG. 11.

The process of FIG. 11 may include representing the authors, raters, and comments as nodes (block 1110). For example, in one implementation, rank calculation component 540 may retrieve information identifying each author, rater, and comment from databases 600 and 700 and may represent each author, rater, and comment as a different node in a graph. The process may further include representing relationships between authors, raters, and comments as edges (block 1110). For example, rank calculation component 540 may provide an edge from a first node that represents an author to a second node that represents the comment that the author submitted. Thus, author nodes may be linked to the comment nodes that the authors submitted. Similarly, rank calculation component 540 may provide an edge from a first node that represents a comment to a second node that represents the author who submitted the comment. Thus, comment nodes may be linked to the author nodes, representing the authors who submitted the comments. Additionally, rank calculation component 540 may provide an edge from a first node that represents a rater and a second node that represents the comment for which the rater has submitted a rating. Thus, rater nodes may be linked to the comment nodes for which rater nodes have submitted ratings and comment nodes may be linked to rater nodes. Additionally, rank calculation component 540 may provide an edge from a first node that represents a user in his/her author capacity and a second node that represents the user in his/her rater capacity and an edge from the second node to the first node. Thus, a user's author node may be linked to the user's rater node and a user's rater node may be linked to the user's author node. In this way, a user's reputation as a rater can influence (positively or negatively) the user's reputation as an author, and vice versa. In some implementations, some of the above edges may be weighted more heavily than others of the above edges.

In some implementations, a first author may identify one or more second authors as “favorite” authors or may subscribe to receive indications when the one or more second authors submit comments. In these implementations, rank calculation component 540 may provide an edge from a first node, representing a first user acting in his/her author capacity, and a second node, representing a second user acting in his/her author capacity, where the first user has indicated the second user as a “favorite” or has subscribed to the second user. In this way, a user's author reputation can be influenced by another user's author reputation.

The process may further include assigning initial values to the nodes in the graph (block 1120). For example, rank calculation component 540 may assign the initial author scores (e.g., as calculated above with respect to FIG. 8) to the appropriate author nodes. In addition, rank calculation component 540 may assign the initial rater scores (e.g., as calculated above with respect to FIG. 9) to the appropriate rater nodes. Further, rank calculation component 540 may assign the initial comment scores (e.g., as calculated above with respect to FIG. 10) to the appropriate comment nodes.

The process may further include calculating ranking scores for all the nodes in the graph (block 1130). In one implementation, rank calculation component 540 may use an algorithm similar to the PageRank™ algorithm to calculate the ranking scores for the nodes. Thus, for example, rank calculation component 540 may run iterations of the graph algorithm (where all or a portion of the initial scores of the nodes are conveyed to nodes to which the node links). Other techniques for calculating the ranking scores can alternatively be used.

The process may include determining whether the calculated ranking scores have sufficiently converged and/or a number of iterations have been reached (block 1140). As described above, rank calculation component 540 may run iterations of the graph algorithm until the values of the nodes converge, until a number of iterations (e.g., a threshold number) has been reached, or either when the values of the nodes have converged or the number of iterations has been reached. If the calculated ranking scores have not sufficiently converged and/or the number of iterations has not been reached (block 1140—NO), then rank calculation component 540 may continue running iterations of the graph (block 1130). If, on the other hand, the calculated ranking scores have sufficiently converged or the number of iterations has been reached (block 1140—YES), the ranking scores may be stored (block 1150). For example, rank calculation component 540 may store the ranking scores in one or more databases, such as databases 600 and 700. In one implementation, the storage of the author ranking scores may act to replace the initial author scores in field 620 of database 600, the storage of the rater ranking scores may act to replace the initial rater scores in field 630 of database 600, and the storage of the comment ranking scores may act to replace the initial comment scores in field 720 of database 700.

The process may further include using the calculated ranking scores (block 1160). For example, the author ranking scores may be used for providing a ranked list of authors. Similarly, the rater ranking scores may be used for providing a ranked list of raters. Still further, the comment ranking scores may be used for selecting a highest ranking group of comments for display with a particular document.

Other techniques for calculating the author, rater, and comment ranking scores may alternatively be used. For example, in one implementation, the initial comment ranking scores may be calculated. The initial author ranking scores may be then calculated using the appropriate initial comment scores (in addition to the author signals). Thereafter, when no edges between authors and comments would be necessary when graphically representing the authors, raters, and comments since an initial author score would already reflect the qualities of the comments that the particular author submitted.

### Providing User Information

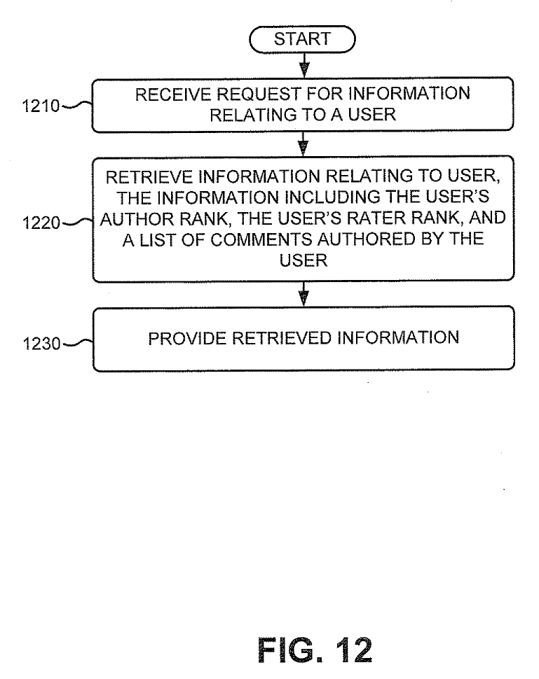

FIG. 12 is a flowchart of an exemplary process for providing user information. In one implementation, the process of FIG. 12 may be performed by one or more components within server 220, client 210, or a combination of client 210 and server 220. In another implementation, the process may be performed by one or more components within another device or a group of devices separate from or including client 210 and/or server 220. Also, while FIG. 12 shows blocks in a particular order, the actual order may differ. For example, some blocks may be performed in parallel or in a different order than shown in FIG. 12.

The process of FIG. 12 may include receiving a request for information relating to a user (block 1210). In one implementation, server 220 may receive the request from a client 210. The request may include information identifying the user. The request may be submitted to server 220 in response to a command from a user of client 210 (e.g., in response to the user selecting a link or button on a provided graphical user interface, in response to the user selecting a menu item, in response to the user submitting a request for a particular web page, etc.).

The process may further include retrieving the requested information from a database, such as database 600 or another database (block 1220). The retrieved information may include, for example, the user's author ranking score, the user's rater ranking score, and a list of comments that the user has authored and/or rated. The retrieved information may include additional, fewer, or different information relating to the user.

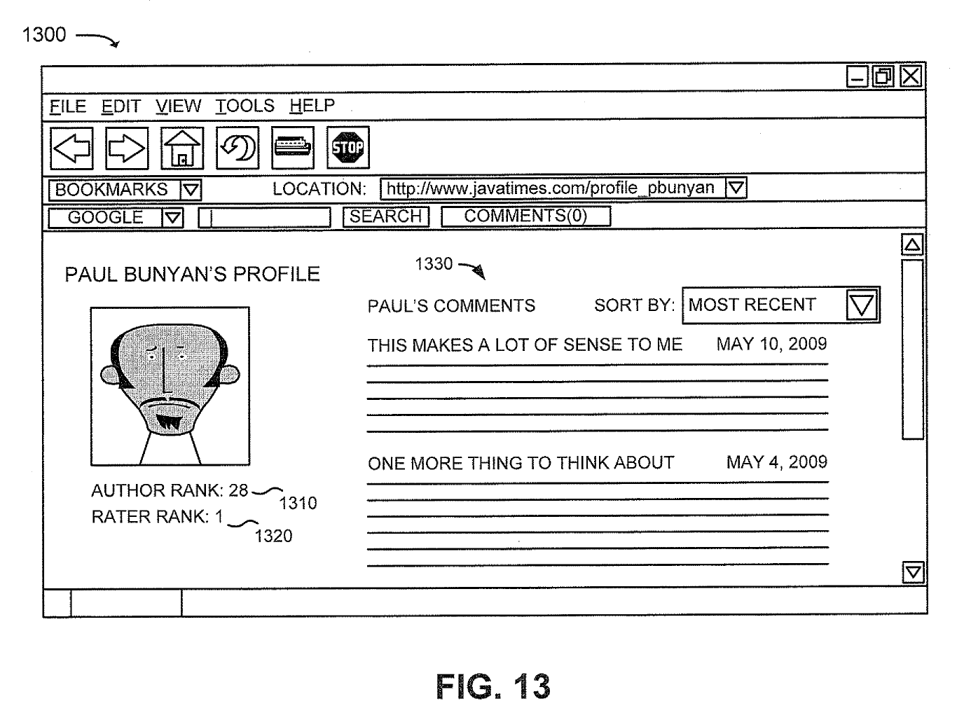

The process may further include providing the retrieved information (block 1230). For example, server 220 may provide a graphical user interface to client 210 that depicts the retrieved information. FIG. 13 is a diagram of an exemplary graphical user interface 1300 that may be provided to a client 210. As illustrated in FIG. 13, graphical user interface 1300 may provide information about the requested user (“Paul Bunyan” in this example). The information may include a picture of the user, the user's author ranking 1310 (depicted as “2” in this example), the user's rater ranking 1320 (depicted as “1” in this example), and a sortable list 1330 of the user's comments. Thus, in exemplary graphical user interface 1300, Paul Bunyan is the 28^{th} highest ranking author of the system and the highest ranked rater of the system. Although not depicted in FIG. 13, graphical user interface 1300 may also include a list of comments that the user has rated and the rating given to those comments by the user. In this way, the user's reputation may be divided between the different roles in which the user acts. That is, the user's reputation as an author and the user's reputation as a rater may be provided. By separately providing the user's author reputation and rater reputation, users may be encouraged to author comments and to rate comments, wanting to be the highest ranking in one or both categories.

### Providing Rater Rankings

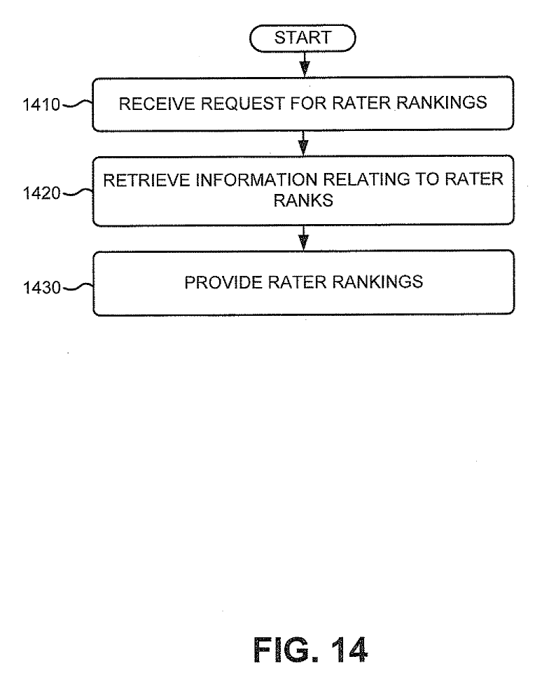

FIG. 14 is a flowchart of an exemplary process for providing rater rankings. In one implementation, the process of FIG. 14 may be performed by one or more components within server 220, client 210, or a combination of client 210 and server 220. In another implementation, the process may be performed by one or more components within another device or a group of devices separate from or including client 210 and/or server 220. Also, while FIG. 14 shows blocks in a particular order, the actual order may differ. For example, some blocks may be performed in parallel or in a different order than shown in FIG. 14.

The process of FIG. 14 may include receiving a request for rater rankings (block 1410). In one implementation, server 220 may receive, from a client 210, a request for the rankings of the raters of the system. The request may be submitted to server 220 in response to a command from a user of client 210 (e.g., in response to the user selecting a link or button on a provided graphical user interface, in response to the user selecting a menu item, in response to the user submitting a request for a particular web page, etc.).

The process may further include retrieving rater ranking information from a database, such as database 600 or another database (block 1420). For example, server 220 may access database 600 and retrieve information identifying the users (e.g., from field 610) and the corresponding ranking values from rater ranking field 630.

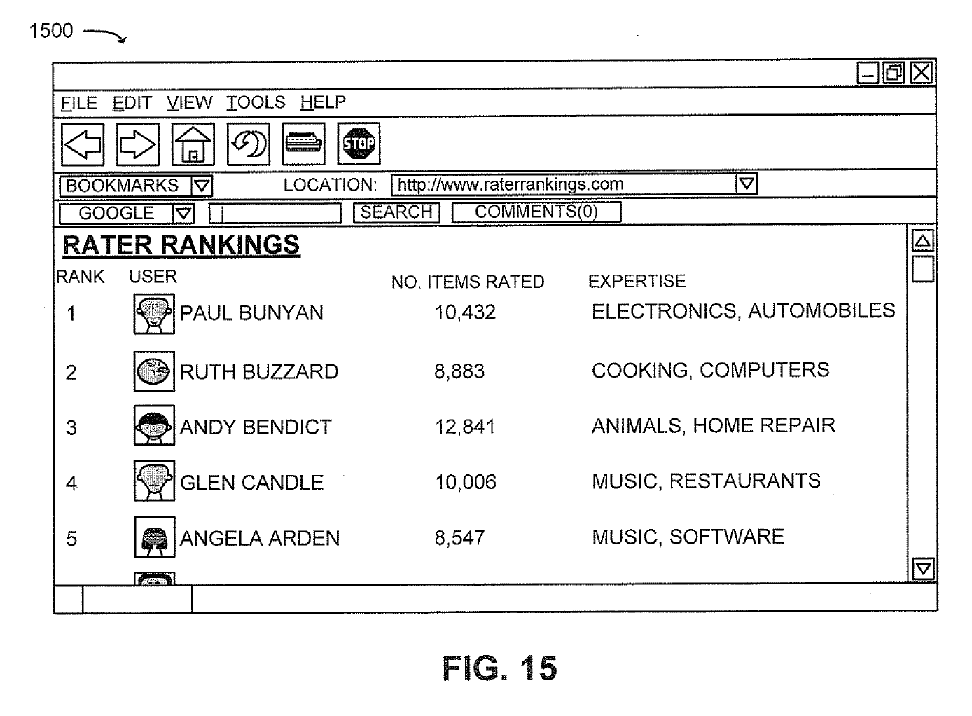

The process may include providing the rater ranking information (block 1430). For example, server 220 may provide the rater ranking information, sorted based on rank (i.e., with the highest ranking rater listed first). FIG. 15 is a diagram of an exemplary graphical user interface 1500 that may provide rater ranking information. As illustrated in FIG. 15, graphical user interface 1500 may provide a ranked list of raters. As illustrated, user “Paul Bunyan” is the highest ranking rater. Each user may be associated information, such as the number of items rated, topical categories in which the user is considered to be an expert rater, etc. To determine whether a user is an expert in a particular topical category, comments component 410 may, for example, calculate a ranking score for the user for different topical categories (such as electronics, automobiles, etc.). Comments component 410 may select one or more of the topical categories in which the user ranks the highest as the categories of expertise for the user. In a similar manner, comments component 410 may determine that a particular user is a better rater for comments in a first language (e.g., English) than comments in a second language (e.g., Spanish). As yet another example, comments component 410 may determine, for example, based on the geographic location of a particular user, that the user is a better rater of comments that relate to the user's geographic location than for comments that relate to a different geographic location. For example, if the user lives in California, comments component 410 may determine that the user is better at rating comments about California than another user who lives in New York. Graphical user interface 1500 may further provide these other types of information. By providing rater rankings, users of the system will be encouraged to rate comments, attempting to become the highest ranking rater.

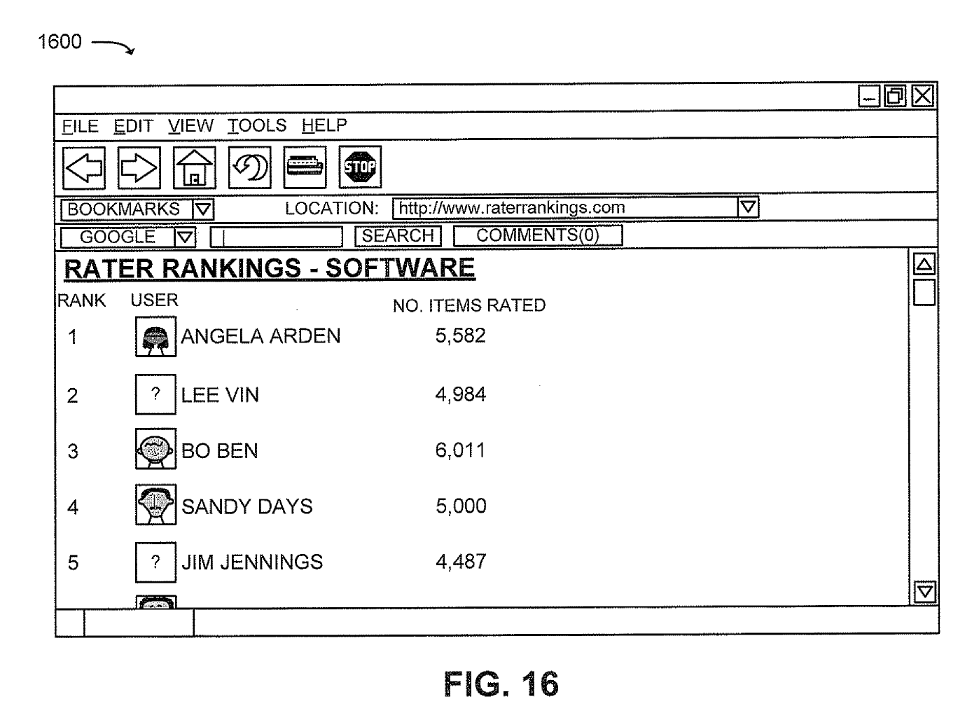

In one implementation, the topical categories depicted in FIG. 15 may be provided as selectable links. In response to selection of a topical category (such as “software”), a graphical user interface may be provided that lists the highest ranking raters for that particular topical category. FIG. 16 is a diagram of an exemplary graphical user interface 1600 that may be provided in response to selection of a topical category in graphical user interface 1500. As illustrated in FIG. 16, graphical user interface 1600 may provide a ranked list of raters for the topical category “software.” As illustrated, user “Angela Arden” is the highest ranking user in the software category. Each user may be associated information, such as the number of comments rated in that topical category, etc. By providing rater rankings in particular topical categories, users of the system will be encouraged to rank comments in particular categories, attempting to become the highest ranking rater for those categories.

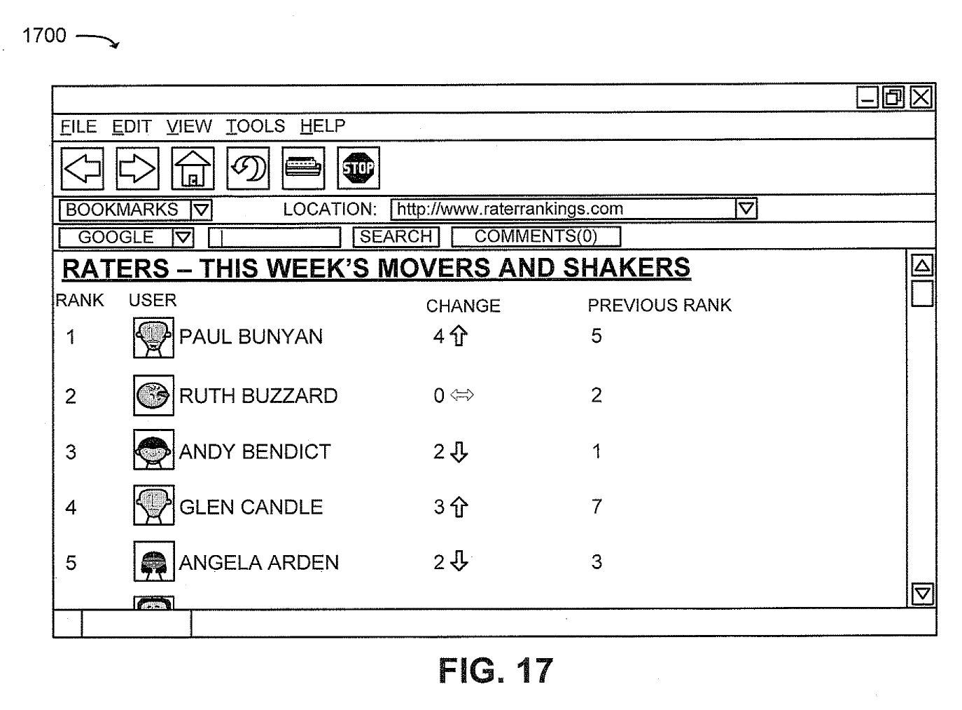

FIG. 17 is a diagram of an exemplary graphical user interface 1700 that may be provided to a user. As illustrated in FIG. 17, graphical user interface 1700 may provide information regarding changes of rater rankings over a time period. In exemplary graphical user interface 1700, the time period is a week. Other time periods may alternatively be used. As illustrated, user “Paul Bunyan” is the highest ranking rater and this user has moved up four spots in the past week. By providing the changes in rater rankings, users whose rankings are shown to be moving up in the list will be encouraged to continue to rate comments and those users whose rankings are shown to be moving down the list will be encourage to rate more comments in hopes of reversing this trend. Similar graphical user interfaces to those depicted in FIGS. 15-17 may be provided for author rankings.

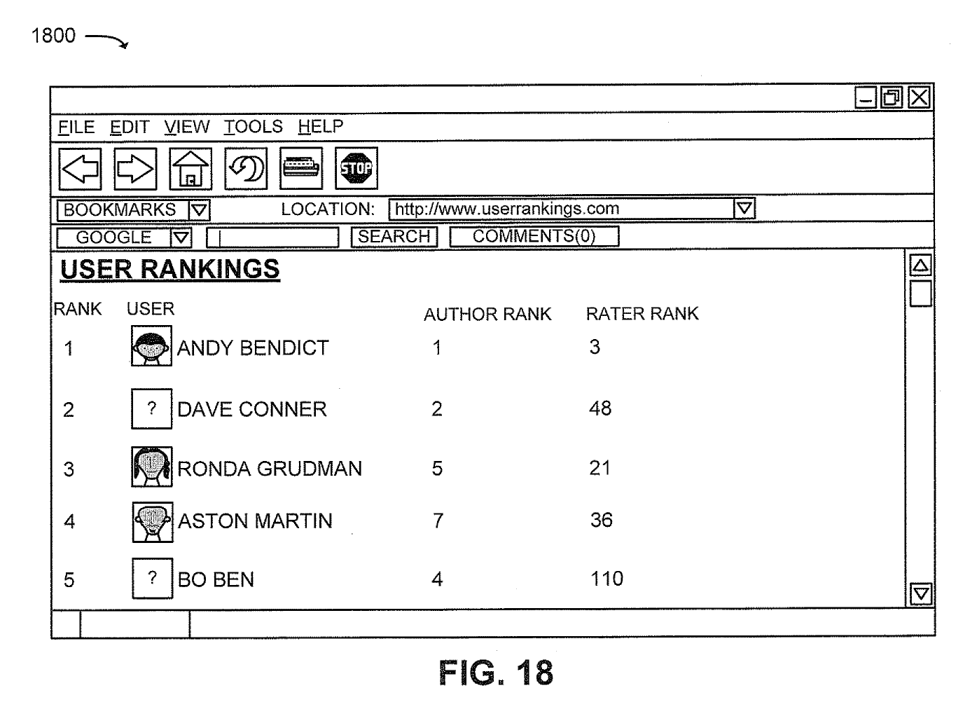

As described above in connection with FIG. 5, comments component 410 may calculate a user ranking score by combining, in some fashion, the user's author ranking score with the user's rater ranking score. FIG. 18 is a diagram of an exemplary graphical user interface 1800 that may provide user ranking information. As illustrated in FIG. 18, graphical user interface 1800 may provide a ranked list of users. In FIG. 18, user “Andy Bendict” is the highest ranking user. Each user may be associated with information, such as the user's author rank, the user's rater rank, etc. By providing user rankings, which reflect the different roles in which the users may act, users of the system will be encouraged to author comments and rate comments, attempting to become the highest ranking user.

### Conclusion

Implementations, described herein, may separate a user's reputation into different roles: as an author and as a rater. Ranking values may be determined for each of the user's different roles and these ranking values may be used to rank the comments that the user authored and rated.

The foregoing description provides illustration and description, but is not intended to be exhaustive or to limit the invention to the precise form disclosed. Modifications and variations are possible in light of the above teachings or may be acquired from practice of the invention.

For example, while a particular manner of calculating an initial rater score was described above with respect to FIG. 9, the initial rater score may be determined in other ways. For example, comments component 410 may calculate an initial author rank score for a particular user and use this score as the user's initial rater rank score. Alternatively, the user's rater ranking score may be ignored during the calculation of the author ranking scores and comment ranking scores, as described in connection with FIG. 11.

Also, certain portions of the implementations have been described as “logic” or a “component” that performs one or more functions. The terms “logic” or “component” may include hardware, such as a processor, an ASIC, or a FPGA, or a combination of hardware and software (e.g., software running on a general purpose processor that transforms the general purpose processor to a special-purpose processor that functions according to the exemplary processes described above).

Further, it has been described that scores are generated for authors, raters, and/or comments. The scoring scheme has been described where higher scores are better than lower scores. This need not be the case. In another implementation, the scoring scheme may be switched to one in which lower scores are better than higher scores.

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method performed by one or more server devices comprising:
receiving, from a user and at a processor of the one or more server devices, a first comment associated with a web page, the user acting in an author capacity with respect to the first comment;
receiving, from the user and at a processor of the one or more server devices, a rating of a second comment, the second comment being different from the first comment, the user acting in a rater capacity with respect to the second comment;
calculating, using a processor of the one or more server devices, a first ranking score for the user acting in the author capacity based on one or more first signals;
calculating, using a processor of the one or more server devices, a second ranking score for the user acting in the rater capacity based on one or more second signals, where the one or more second signals are different from the one or more first signals; and
providing one of:
a first ranked list that includes a plurality of authors, the user being placed in the first list according to the first ranking score, or
a second ranked list that includes a plurality of raters, the user being placed in the second list according to the second ranking score.

2. The method of claim 1, where the calculating the first ranking score includes:
calculating a first initial score for the user acting in the author capacity using the one or more first signals,
where the calculating the second ranking score includes:
calculating a second initial score for the user acting in the rater capacity using the one or more second signals, and
where the calculating the first ranking score and the calculating the second ranking score include:
representing the user acting in the author capacity as a first node in a graph,
assigning the first initial score to the first node,
representing the user acting in the rater capacity as a second node in the graph,
assigning the second initial score to the second node,
adding a first link from the first node to the second node,
adding a second link from the second node to the first node, and
iteratively running a graph algorithm, until convergence or a number of iterations have been reached, to calculate the first ranking score and the second ranking score.

3. The method of claim 1, where the calculating the first ranking score and the calculating the second ranking score occur during a same process.

4. The method of claim 1, further comprising:
calculating a third ranking score for the user by combining the first ranking score and the second ranking score, the third ranking score reflecting an overall reputation of the user.

5. The method of claim 4, where the first ranking score is weighted more heavily than the second ranking score when combining the first ranking score and the second ranking score to calculate the third ranking score.

6. The method of claim 1, further comprising:
providing a graphical user interface that depicts information about the user, the information including the first ranking score for the user acting in the author capacity and the second ranking score for the user acting in the rater capacity.

7. The method of claim 1, where the first comment relates to a first topical category,
where the first ranking score is for the user acting in the author capacity with respect to comments categorized in the first topical category,
where the method further comprises:
receiving a third comment, from the user, that relates to a second topical category, the second topical category being different from the first topical category, the user acting in the author capacity with respect to the third comment; and
calculating a third ranking score for the user acting in the author capacity with respect to comments categorized in the second topical category, the third ranking score being independent of the first ranking score.

8. The method of claim 1, where the first comment relates to a first topical category,
where the first ranking score is for the user acting in the author capacity with respect to comments categorized in the first topical category,
where the method further comprises:
providing a graphical user interface that includes a ranked list of authors for the first topical category, the user being placed in the list at a location based on the calculated first ranking score.

9. The method of claim 1, where the second comment relates to a first topical category,
where the second ranking score is for the user acting in the rater capacity with respect to comments categorized in the first topical category,
where the method further comprises:
receiving a rating from the user for a third comment, the third comment relating to a second topical category, the second topical category being different from the first topical category, the user acting in the rater capacity with respect to the second topical category; and
calculating a third ranking score for the user acting in the rater capacity with respect to comments in the second topical category, the third ranking score being independent of the second ranking score.

10. The method of claim 1, where the second comment relates to a first topical category,
where the second ranking score is for the user acting in the rater capacity with respect to comment in the first topical category, and
where the method further comprises:
providing a graphical user interface that includes a ranked list of raters for the first topical category, the user being placed in the list at a location based on the calculated second ranking score.

11. One or more server devices comprising:
a processor to:
receive, from a user, a first comment for a web page, the user acting in an author capacity with respect to the first comment,
receive, from the user, a rating of a second comment, the second comment being different from the first comment, the user acting in a rater capacity with respect to the second comment,
determine a first ranking score for the user acting in the author capacity, the first ranking score being based on one or more first signals, and
determine a second ranking score for the user acting in the rater capacity, the second ranking score being based on one or more second signals, the one or more second signals being different from the one or more first signals; and
a memory to:
store the first ranking score, and
store the second ranking score.

12. The one or more server devices of claim 11, where, when determining the first ranking score, the processor is to:
calculate a first initial score for the user acting in the author capacity,
where, when determining the second ranking score, the processor is to:
calculate a second initial score for the user acting in the rater capacity,
where the processor is further to:
calculate a third initial score for the first comment, the third initial score reflecting an indication of quality of the first comment, and
where, when determining the first ranking score and determining the second ranking score, the processor is to:
represent the user acting in the author capacity as a first node in a graph,
represent the user acting in the rater capacity as a second node in the graph,
represent the first comment as a third node in the graph,
add a first link from the first node to the second node,
add a second link from the second node to the first node,
add a third link from the first node to the third node,
add a fourth link from the third node to the first node,
assign the first initial score to the first node,
assign the second initial score to the second node,
assign the third initial score to the third node,
iteratively run a graph algorithm, until convergence or until a number of iterations have been reached, to determine the first ranking score and the second ranking score.

13. The one or more servers of claim 12, where, when iteratively running the graph algorithm, the processor is to further determine a third ranking score for the first comment, the third ranking score reflecting an indication of quality of the first comment.

14. The one or more servers of claim 11, where the processor is further to:
receive a request for a ranked list of raters, and
provide, in response to the request, a graphical user interface that includes a list of a plurality of raters, the user being placed in the list at a location based on the second ranking score.

15. The one or more servers of claim 11, where the memory includes a database, the database storing information identify the user, information identifying the first ranking score, and information identifying the second ranking score.

16. A system comprising:
one or more devices comprising:
means for determining a first reputation for a user acting in an author capacity;
means for determining a second reputation for the user acting in a rater capacity, the second reputation being determined differently than the first reputation;
means for determining an overall reputation for the user based on the first reputation and the second reputation; and
means for providing a ranked list of users, the user being placed in the list at a location based on the overall reputation.

17. The system of claim 16, further comprising:
means for providing a graphical user interface that depicts information about the user, the information includes information identifying the first reputation and information identifying the second reputation.

18. The system of claim 16, where the means for determining an overall reputation for the user includes:
means for combining the first reputation and the second reputation to obtain the overall reputation, the first reputation being weighted more heavily than the second reputation when combining the first reputation and the second reputation.

19. A computer-readable medium containing instructions executable by one or more devices, comprising:
one or more instructions to represent a plurality of users, acting in author capacities, as first nodes;
one or more instructions to represent the plurality of users, acting in rater capacities, as second nodes;
one or more instructions to represent a plurality of comments as third nodes;
one or more instructions to form first edges from the first nodes to the third nodes based on relationships between the first nodes and the third nodes;
one or more instructions to form second edges from the third nodes to the first nodes based on the relationships between the first nodes and the third nodes;
one or more instructions to form third edges from the second nodes to the third nodes based on relationships between the second nodes and the third nodes;
one or more instructions to form fourth edges from the third nodes to the second nodes based on the relationships between the second nodes and the third nodes;
one or more instructions to form fifth edges from first nodes to the second nodes based on relationships between the first nodes and the second nodes;
one or more instructions to form sixth edges from the second nodes to the first nodes based on the relationships between the first nodes and the second nodes;
one or more instructions to assign initial values to the first nodes, the second nodes, and the third nodes;
one or more instructions to run iterations of a graph algorithm, to obtain ranking values, the iterations being run until values of the first nodes, second nodes, and third nodes converge or until a number of iterations have been reached, where the ranking value of each first node reflects a reputation of the corresponding user acting in the author capacity, where the ranking value of each second node reflects a reputation of the corresponding user acting in the rater capacity, and where the ranking value of each third node reflects an indication of quality of the corresponding comment; and
one or more instructions to provide at least one of:
a list of authors that is ordered based on the ranking values of the first nodes,
a list of raters that is ordered based on the ranking values of the second nodes, or
a ranked list of comments, the comments in the ranked list being selected based using the ranking values of the comments in the ranked list.

20. The computer-readable medium of claim 19, where the plurality of users, acting in the author capacities, corresponds to authors who have submitted comments relating to a first topical category,
where the plurality of users, acting in the rater capacities, corresponds to raters who have submitted ratings for the comments relating to the first topical category, and
where the plurality of comments relates to the first topical category.

21. The computer-readable medium of claim 19, where the computer-readable medium further includes:
one or more instructions for obtaining ranking values for a second plurality of comments relating to a second topical category, the second topical category being different than the first topical category, and for a second plurality of users acting in author capacities and in rater capacities with respect to the second plurality of comments.

22. A method comprising:
maintaining, in a memory associated with one or more server devices, a database that associates, for each user of a plurality of users, an identifier for the user with information identifying a first ranking score of the user acting in an author capacity with respect to one or more first comments and a second ranking score of the user acting in a rater capacity with respect to one or more second comments;
receiving, at a processor associated with the one or more server devices, a request for a ranking of raters;
retrieving, in response to receiving the request and using a processor associated with the one or more server devices, the user identifiers and the second ranking scores, associated with the users, from the database; and
providing, using a processor associated with one or more server devices, a list of the user identifiers, where the user identifiers in the list are ranked according to the second ranking scores associated with the users.

23. The method of claim 22, where the one or more second comments relate based on a first criterion,
where the database further associates, for at least one user of the plurality of users, the identifier for the at least one user with information identifying a third ranking score of the user as a rater of one or more third comments, the one or more third comments relating based on second criterion, the second criterion being different than the first criterion, and
where the method further comprises:
receiving a second request for a ranking of raters with respect to the second criterion;
retrieving, in response to receiving the second request, the user identifiers and third ranking scores from the database; and
providing a second list of user identifiers, ranked according to the third ranking scores associated with the users.

24. The method of claim 22, further comprising:
calculating, prior to the maintaining, the first ranking scores and the second ranking scores, the calculating including:
representing, as first nodes, the plurality of users acting in author capacities,
representing, as second nodes, the plurality of users acting in rater capacities,
representing, as third nodes, the one or more first comments and the one or more second comments,
forming first edges from the first nodes to the third nodes based on relationships between the first nodes and the third nodes,
forming second edges from the third nodes and the first nodes based on the relationships between the first nodes and the third nodes,
forming third edges from the second nodes to the third nodes based on relationships between the second nodes and the third nodes,
forming fourth edges from the third nodes to the second nodes based on the relationships between the second nodes and the third nodes,
forming fifth edges from the first nodes to the second nodes based on relationships between the first nodes and the second nodes,
forming sixth edges from the second nodes to the first nodes based on the relationships between the first nodes and the second nodes,
assigning initial values to the first nodes, the second nodes, and the third nodes, and
running iterations of a graph algorithm to obtain the first ranking scores, the second ranking scores, and third ranking scores, the iterations are run until values of the first nodes, second nodes, and third nodes converge or until a number of iterations have been reach, the third ranking scores reflecting indications of quality of the one or more first comments and the one or more second comments.

25. A method performed by one or more server devices, the method comprising:
determining, using a processor of the one or more server devices, a first reputation for a user acting in a first role;
determining, using a processor of the one or more server devices, a second reputation for the user acting in a second role, the second role being different than the first role;
associating, in a memory associated with the one or more server devices, an identifier of the user with a first value representing the first reputation and a second value representing the second reputation; and
providing, using a processor of the one or more server devices, a ranked list of users, the user being placed in the ranked list at a location based on the first reputation or the second reputation.

26. The method of claim 25, where the first role corresponds to the user acting in an author capacity for a first comment in a first category, and
where the second role corresponds to the user acting in the author capacity for a second comment in a second category, the second category being different than the first category.

27. The method of claim 25, where the first role corresponds to the user acting in a rater capacity for a first comment in a first category, and
where the second role corresponds to the user acting in the rater capacity for a second comment in a second category, the second category being different than the first category.

28. The method of claim 25, where the first role corresponds to the user acting in an author capacity for a first comment, and
where the second role corresponds to the user acting in a rater capacity for a second comment.
